(19) United States
(12) Patent Application Publication
(10) Pub. No.: US 2009/0262187 A1
(43) Pub. Date: Oct. 22, 2009

(54) INPUT DEVICE

(76) Inventors: Yukinori Asada, Chigasaki (JP); Takashi Matsubara, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/427,858

(22) Filed: Apr. 22, 2009

(30) Foreign Application Priority Data
Apr. 22, 2008 (JP) JP 2008-110838

(51) Int. Cl. H04N 7/18; G06F 3/033; G09G 5/00

(52) U.S. Cl. 348/77; 715/863; 345/156; 348/E07.085

(57) ABSTRACT

The input device of the present invention includes a camera for taking an image of an operator, an image recognition unit for recognizing a partial portion of body of the operator as the image taken by the camera, a display-area calculation unit for calculating a display area in such a manner that the partial portion of the body of the operator recognized by the image recognition unit is selected and used as its criterion, the display area being used for displaying a graphical user interface for the operator to perform an operation, and a display screen for displaying the graphical user interface as well as the partial portion of the body of the operator within the display area calculated by the display-area calculation unit.

The present application claims priority from Japanese applications JP 2008-110838 filed on Apr. 22, 2008, the content of which is hereby incorporated by reference into this application.

### BACKGROUND OF THE INVENTION

1. Field of the Invention

The present invention relates to an input device for detecting a movement of a person, and implementing an intuitive operation based on the movement detected and a graphical user interface. More particularly, it relates to a display method for the graphical user interface.

2. Description of the Related Art

There has been a widespread prevalence of personal computers and televisions which receive an operation by a user via a graphical user interface, and which, simultaneously, offer a feedback for the operation result to the user.

Meanwhile, camera-installed personal computers start to prevail.

Under the circumstances like this, consideration is now being given to the technologies for allowing televisions and personal computers to be operated based on a movement of the user photographed by a camera, i.e., without the user's manually handling an input device such as remote controller.

For example, an object of the invention disclosed in JP-A-2006-235771 is to provide a remote control device which allows implementation of an intuitive operation without using a complicated image processing. Namely, in this remote control device, the graphical user interface displayed on a display device is operated as follows: An image to be displayed on the display device is divided into a predetermined number of areas corresponding to the intuitive operation. Moreover, a movement amount for indicating a change between an immediately-before image and the present image is calculated on each divided-area basis, thereby operating the graphical user interface.

### SUMMARY OF THE INVENTION

In FIG. 8A to FIG. 8C of JP-A-2006-235771, there is disclosed a technology whereby, when one of a plurality of viewers operates a graphical user interface, he or she changes factors such as size, shape, and position of the graphical user interface.

In FIG. 8A to FIG. 8C, however, the display area of the graphical user interfaces becomes narrower by the amount in which display of the operator becomes smaller within the screen. As a result, depending on the person, the narrower display area causes a danger that the graphical user interfaces become difficult to see from a distance, and thus become difficult to operate.

Also, as are shown in JP-A-2006-235771, if the graphical user interfaces are displayed at four corners of a rectangular display area in the center of which the operator to be displayed is positioned, there occur disadvantages such that the operator must raise his or her hand over his or her shoulder. As a result, depending on the person, it can not necessarily be said that the graphical user interfaces are easy to operate.

Taking the problems like this into consideration, an object of the present invention is to provide the following input device: Namely, in this input device, the display area of a graphical user interface can be changed, or criterion for the display area of the graphical user interface can be changed, so that the user finds it by far the easiest to operate the graphical user interface. Simultaneously, it is made possible for the user to set these changes arbitrarily.

In order to accomplish the above-described object, an input device according to a first aspect of the present invention includes a camera for taking an image of an operator, an image recognition unit for recognizing a partial portion of body of the operator as the image taken by the camera, a display-area calculation unit for calculating a display area in such a manner that the partial portion of the body of the operator recognized by the image recognition unit is selected and used as its criterion, the display area being a range within which the operator can operate a graphical user interface for performing an operation, and a display screen for displaying the graphical user interface as well as something within the display area calculated by the display-area calculation unit, something being equivalent to the partial portion of the body of the operator.

Moreover, if the display area to be displayed within the display screen is smaller than the display screen, the display area is calculated in a manner of being enlarged, and the enlarged display area is displayed within the display screen. Also, the partial portion of the body recognized by the image recognition unit is a face, both hands, or one hand.

Furthermore, an input device according to a second aspect of the present invention includes a camera for taking an image of an operator, an image recognition unit for recognizing a partial portion of body of the operator as the image taken by the camera, a display-area calculation unit for calculating a display area in such a manner that the partial portion of the body of the operator recognized by the image recognition unit is selected and used as its criterion, the display area being a range within which the operator can operate a graphical user interface for performing an operation, a display screen for displaying the graphical user interface as well as something within the display area calculated by the display-area calculation unit, something being equivalent to the partial portion of the body of the operator, and a setting unit for changing the display area to be displayed within the display screen.

Concretely, it is assumed that the setting unit can set either enlarging the display area or leaving the display area as it is.

In addition, an input device according to a third aspect of the present invention includes a camera for taking an image of an operator, an image recognition unit for recognizing a partial portion of body of the operator as the image taken by the camera, a display-area calculation unit for calculating a display area in such a manner that the partial portion of the body of the operator recognized by the image recognition unit is selected and used as its criterion, the display area being a range within which the operator can operate a graphical user interface for performing an operation, a display screen for displaying the graphical user interface as well as something within the display area calculated by the display-area calculation unit, something being equivalent to the partial portion of the body of the operator, and a setting unit for changing which portion to be selected and determined as the partial portion of the body recognized by the image recognition unit.

Concretely, the portion of the body, which becomes the change target, is a face, both hands, or one hand.

According to the present invention, the display area of a graphical user interface is enlarged. This feature makes it possible to implement an input device which is easy for the user to see and operate.

Also, as an example, not face but hand is selected as the criterion for the display area of a graphical user interface. This feature makes it possible to implement an input device which is easy for the user to operate by a simple movement.

Moreover, it is made possible for the user to arbitrarily set a change in the display area, or a change in the criterion for the display area. This feature makes it possible to implement an input device which allows execution of an operation that is desired more by the user.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic diagram of the operation environment of an input device according to the present invention;

FIG. 2 is a block diagram of the configuration of the input device according to the present invention;

FIG. 3A to FIG. 3C are diagrams for explaining a first embodiment according to the present invention;

FIG. 4 is a flow diagram for explaining the first embodiment according to the present invention;

FIG. 5A to FIG. 5C are diagrams for explaining a second embodiment according to the present invention;

FIG. 6 is a flow diagram for explaining the second embodiment according to the present invention;

FIG. 7 is a flow diagram for explaining the second embodiment according to the present invention;

FIG. 8A to FIG. 8C are the diagrams for explaining the third embodiment according to the present invention;

FIG. 9 is a flow diagram for explaining the third embodiment according to the present invention;

FIG. 10 is a diagram for explaining a fourth embodiment according to the present invention; and

FIG. 11 is a flow diagram for explaining the fourth embodiment according to the present invention.

### DESCRIPTION OF THE EMBODIMENTS

Hereinafter, the explanation will be given below concerning each environment to which the present invention is applied.

### 1st Embodiment

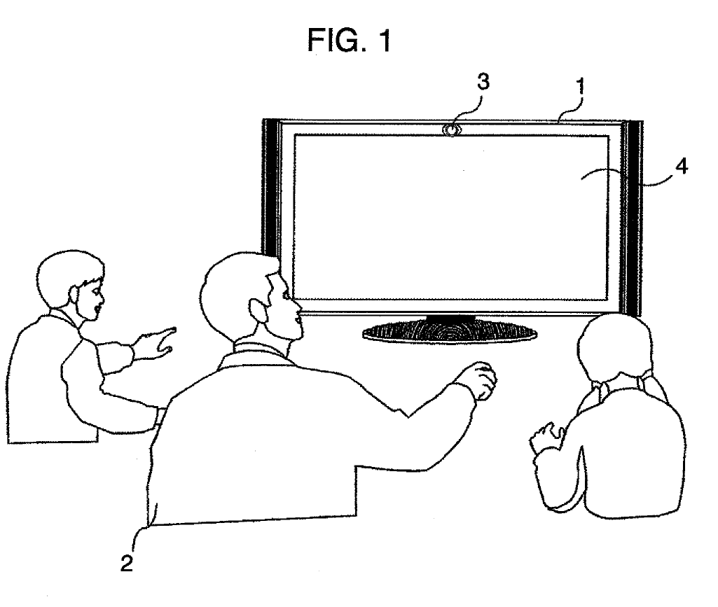

FIG. 1 is a diagram for explaining overview of the operation environment at the time when the present invention is applied to a TV. The reference numerals denote the following configuration components: an input device 1, a display screen 4, a camera 3, and a user 2 who is going to operate the input device 1. The display screen 4, which is a display unit of the input device 1, is configured by a display device such as, e.g., a liquid-crystal display or a plasma display. The display screen 4 is configured by a display panel, a panel control circuit, and a panel control driver. The display screen 4 displays, on the display panel, an image that is configured with data supplied from an image processing unit 103 (which will be described later). The camera 3 is a device such as camera for inputting a motion picture into the input device 1. Incidentally, the camera 3 may be built into the input device 1, or may be connected thereto via code or wireless method. The user 2 is a user who performs an operation with respect to the input device 1. A plurality of users may exist within a range in which the camera 3 is capable of taking images of these users.

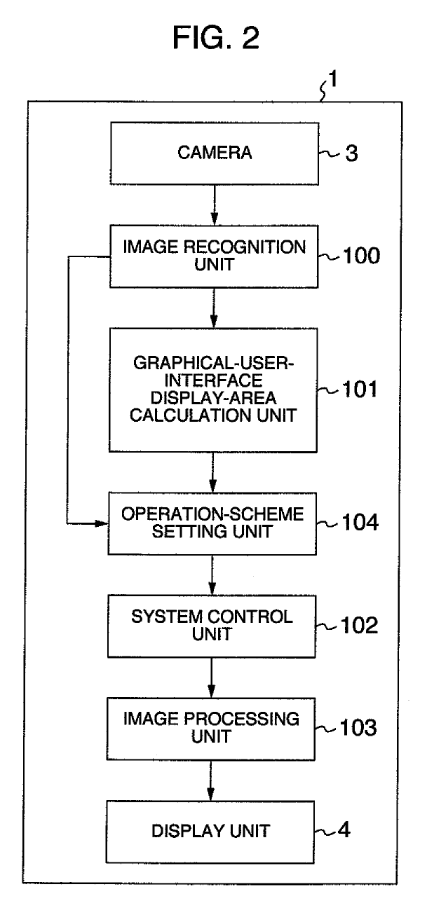

As illustrated in, e.g., FIG. 2, the input device 1 includes at least the camera 3, the display unit 4, an image recognition unit 100, a graphical-user-interface display-area calculation unit 101, a system control unit 102, an image processing unit 103, and an operation-scheme setting unit 104.

The image recognition unit 100 receives a motion picture from the camera unit 3, then detecting a movement of a person from the motion picture that the unit 100 has received. In addition, the unit 100 recognizes the face or hand of the person. The graphical-user-interface display-area calculation unit 101 calculates a display area such as display position, display size, and display range of a graphical user interface. The system control unit 102, which is configured by, e.g., a microprocessor, controls operation of the image processing unit 103. This operation control is executed in order that the data received from the image recognition unit 100 and data on the graphical user interface will be displayed in correspondence with the display area calculated by the graphical-user-interface display-area calculation unit 101. The image processing unit 103 is configured by, e.g., a processing device such as ASIC, FPGA, or MPU. In accordance with the control by the system control unit 102, the image processing unit 103 outputs the data on the image and graphical user interface after converting the data into a manner which is processible on the display screen 4. The operation-scheme setting unit 104 is a component whereby the user 2 selects a predetermined operation scheme arbitrarily. The details of the setting unit 104 will be described later.

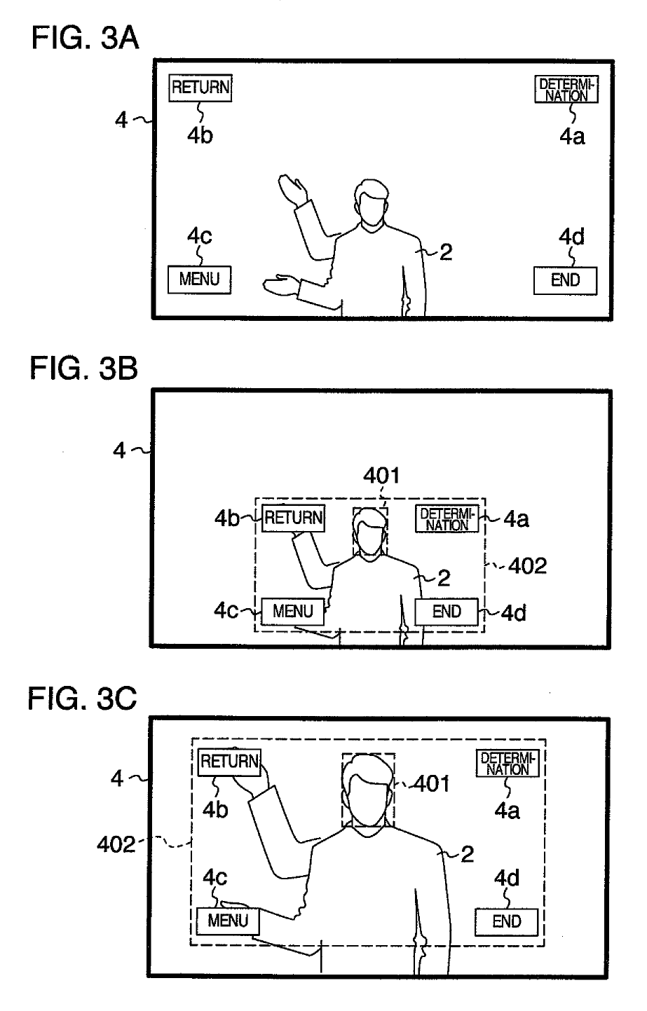

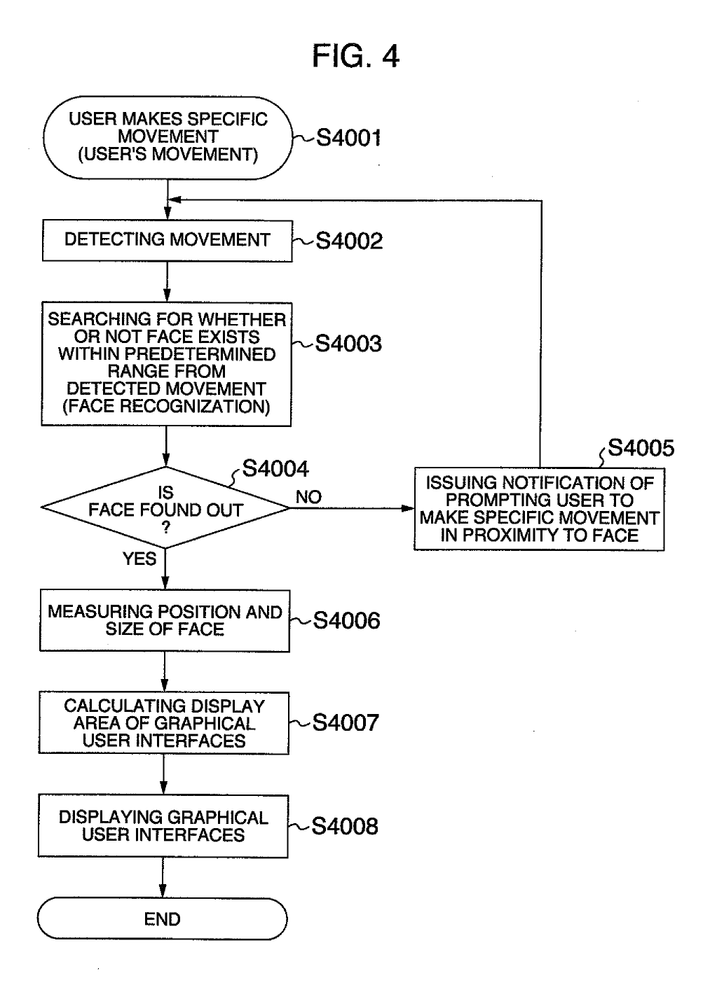

Hereinafter, referring to FIG. 3A to FIG. 3C and FIG. 4, the explanation will be given below concerning the outline of the processing in a first embodiment.

A feature in the present embodiment is as follows: The face of the user 2 is recognized. Then, the display area of a graphical user interface is calculated in correspondence with the position and size of the face recognized.

First, the user 2 makes a specific movement, thereby starting an operation (S4001 in FIG. 4). What is conceivable as the specific movement here is as follows, for example: A movement of waving a hand for a predetermined time-interval, a movement of holding the palm of a hand at rest for a predetermined time-interval with the palm opened and directed to a camera, a movement of holding a hand at rest for a predetermined time-interval with the hand formed into a predetermined configuration, a movement of beckoning, or a movement of using the face such as a blink of eye. By making a specific movement like this, the user 2 expresses, to the input device 1, his or her intention to perform the operation from now on. Having received this intention expression, the input device 1 transitions to a state of accepting the operation by the user 2. Having detected the specific movement of the user 2 (S4002 in FIG. 4), the image recognition unit 100 searches for whether or not the face of the user 2 exists within a predetermined range from the position at which the specific movement has been detected (S4003 in FIG. 4). If the face has been not found out (S4004 No in FIG. 4), the input device issues a notification of prompting the user 2 to make the specific movement in proximity to the face (S4005 in FIG. 4). As the method for the notification, the notification may be displayed on the display device 4, or may be provided by voice or the like. Meanwhile, if the face has been found out (S4004 Yes in FIG. 4), the input device measures the position and size of the detected face with respect to the display area of the display device 4 (S4006 in FIG. 4). Next, the graphical-user-interface display-area calculation unit 101 calculates a display area of graphical user interfaces based on the position and size of the detected face (S4007 in FIG. 4), then displaying the graphical user interfaces (S4008 in FIG. 4). Hereinafter, referring to FIG. 3B and FIG. 3C, the explanation will be given below regarding examples of the display area of the graphical user interfaces based on the position and size of the detected face. In FIG. 3B and FIG. 3C, the reference numerals denote the following configuration components: 4a to 4d examples of the graphical user interfaces, the area of the detected face 401, and the display area 402 of the graphical user interfaces which the graphical-user-interface display-area calculation unit 101 has calculated in correspondence with the area 401 of the detected face.

In the example in FIG. 3B, the graphical user interfaces 4a to 4d are simply deployed within a range in which the hand of the user 2 can reach the graphical user interfaces with respect to the area 401 of the face. In this case, however, the display area of the graphical user interfaces becomes narrower. As a result, by the amount equivalent thereto and depending on the person, the narrower display area causes a danger that the graphical user interfaces become difficult to see from a distance, and thus become difficult to operate.

In contrast thereto, in the example in FIG. 3C, the display area of the graphical user interfaces is enlarged so that the graphical user interfaces can be displayed as large as possible on the display device 4 with respect to the area 401 of the face. This example makes it possible to enlarge the display area of the graphical user interfaces by making the display screen the maximum one. As a result, the graphical user interfaces become easier to see from a distance, and thus become easier to operate. Nevertheless, in the example in FIG. 3B, there is an advantage that the calculation amount needed for displaying the graphical user interfaces is small.

These two operation schemes may be switched by the user 2, using the operation-scheme setting unit 104. Also, if the face of the user 2 cannot be recognized for a predetermined time-interval, the graphical user interfaces may be deleted.

### 2nd Embodiment

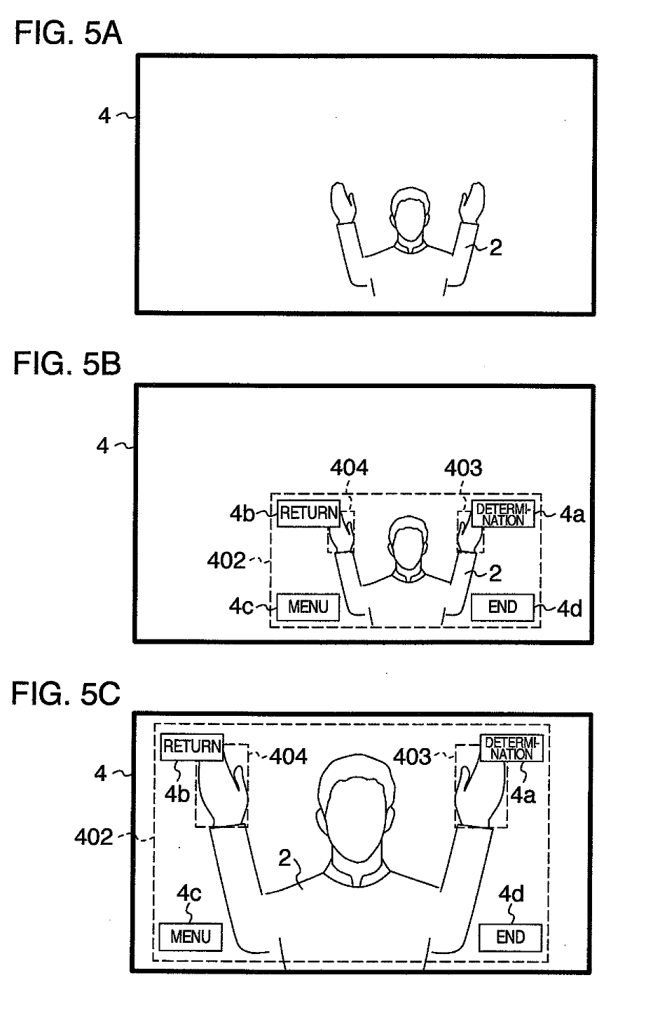

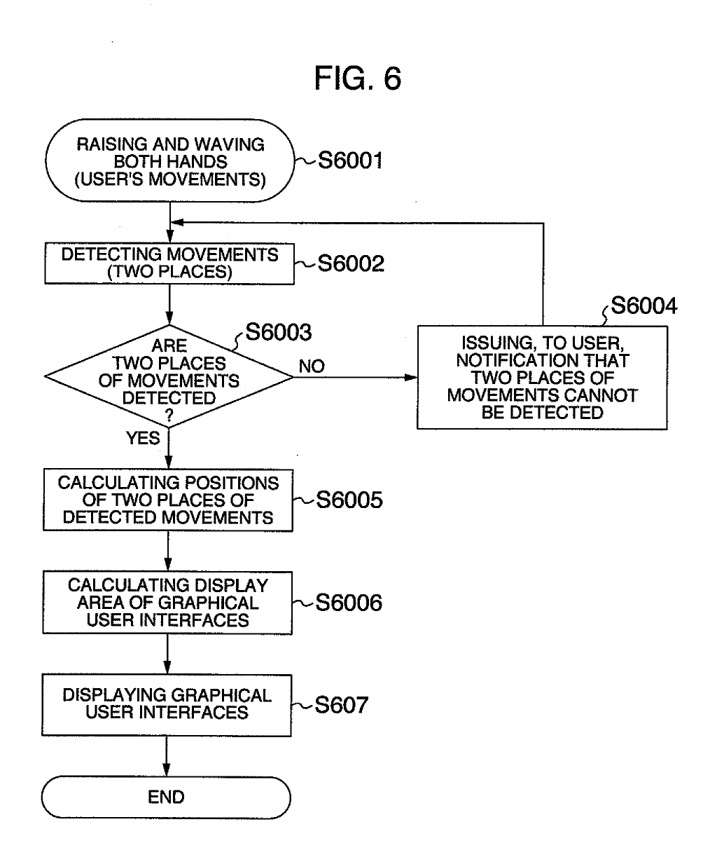

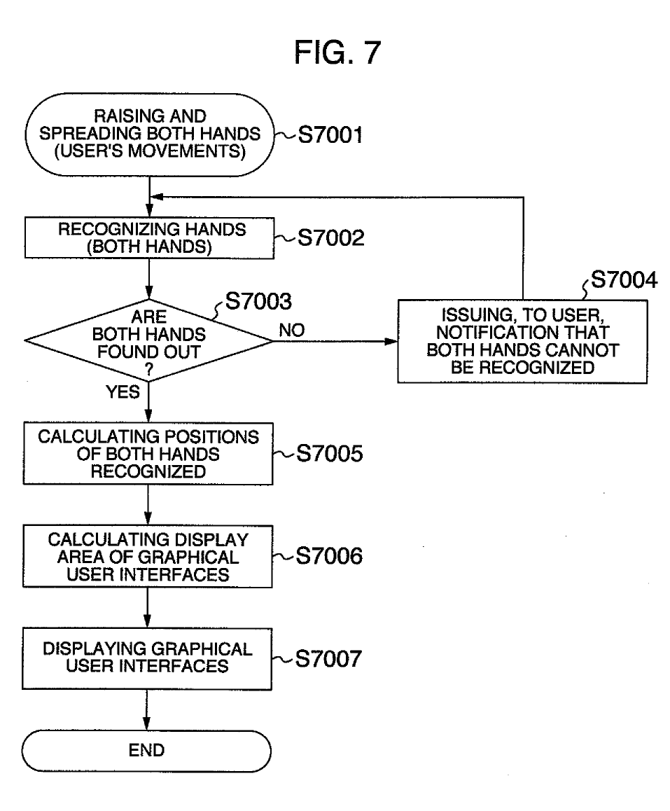

A feature in the present embodiment is as follows: Namely, in the input device 1 explained in the first embodiment, the display area of a graphical user interface is calculated in correspondence with the positions of both hands of the user 2. Hereinafter, referring to FIG. 5A to FIG. 5C, FIG. 6, and FIG. 7, the explanation will be given below concerning this scheme.

First, as illustrated in FIG. 5A, the user 2 raises and waves both hands (S6001 in FIG. 6). Next, the image recognition unit 100 detects the movements of both hands (S6002 in FIG. 6). Here, it turns out that the image recognition unit 100 searches for two areas in each of which each of both hands is moving. Also, since the unit 100 merely detects movements here, detecting the movements of both hands is not necessarily essential. Namely, it is sufficient to be able to detect something moving, anyway. Then, if the image recognition unit 100 has found it unsuccessful to detect the two places of movement portions (S6003 No in FIG. 6), the input device 1 issues, to the user, a notification to the effect that the two places of movement portions cannot be detected (S6004 in FIG. 6). Meanwhile, if the unit 100 has found it successful to detect the two places of movement portions (S6003 Yes in FIG. 6), the input device 1 calculates positions of the two places of movement portions detected (S6005 in FIG. 6). This calculation makes it possible to estimate a range in which the user 2 can perform the operation. Next, the graphical-user-interface display-area calculation unit 101 calculates a display area of graphical user interfaces based on the positions of the two places of movement portions detected (S6006 in FIG. 6), then displaying the graphical user interfaces (S6007 in FIG. 6). Hereinafter, referring to FIG. 5B and FIG. 5C, the explanation will be given below regarding examples of the display area of the graphical user interfaces based on the positions of the two places of movement portions detected. In FIG. 5B and FIG. 5C, the reference numerals 403 and 404 denote areas of the two places of movement portions detected. Similarly to the embodiment illustrated in FIG. 3B and FIG. 3C, the two types of display schemes are conceivable.

In the example in FIG. 5B, the graphical user interfaces 4a to 4d are simply deployed within a range in which both hands of the user 2 can reach the graphical user interfaces with respect to the positions 403 and 404 of the two places of movement portions detected. In this case as well, however, the display area of the graphical user interfaces becomes narrower. As a consequence, by the amount equivalent thereto and depending on the person, the narrower display area causes a danger that the graphical user interfaces become difficult to see from a distance, and thus become difficult to operate.

In contrast thereto, in the example in FIG. 5C, the display area of the graphical user interfaces is enlarged so that the graphical user interfaces can be displayed as large as possible on the display device 4 with respect to the positions 403 and 404 of the two places of movement portions detected. This example makes it possible to enlarge the display area of the graphical user interfaces by making the display screen the maximum one. As a consequence, the graphical user interfaces become easier to see from a distance, and thus become easier to operate. Nevertheless, in the example in FIG. 5B, there is an advantage that the calculation amount needed for displaying the graphical user interfaces is small.

These two operation schemes may be switched by the user 2, using the operation-scheme setting unit 104. Also, if both hands of the user 2 cannot be recognized for a predetermined time-interval, the graphical user interfaces may be deleted.

Also, FIG. 7 is a flow diagram for explaining a method of detecting positions of two places by spreading both hands, and recognizing both of the spread hands themselves. As illustrated in FIG. 5A, the user 2 raises and spreads both hands, then making a movement of directing both of the spread hands to the camera unit 3 (S7001 in FIG. 7). Next, the image recognition unit 100 recognizes each of both hands (S7002 in FIG. 7). Then, if the image recognition unit 100 has found it unsuccessful to detect the two places of hands (S7003 No in FIG. 7), the input device 1 issues, to the user, a notification to the effect that the two places of hands cannot be detected (S7004 in FIG. 7). Meanwhile, if the unit 100 has found it successful to detect the two places of hands (S7003 Yes in FIG. 7), the input device 1 calculates positions of the two places of hands detected (S7005 in FIG. 7). Next, the graphical-user-interface display-area calculation unit 101 calculates a display area of graphical user interfaces based on the positions of both hands recognized (S7006 in FIG. 7), then displaying the graphical user interfaces (S7007 in FIG. 7). Examples of the display area of the graphical user interfaces based on the positions of both hands recognized are, eventually, basically the same as those in FIG. 5B and FIG. 5C.

### 3rd Embodiment

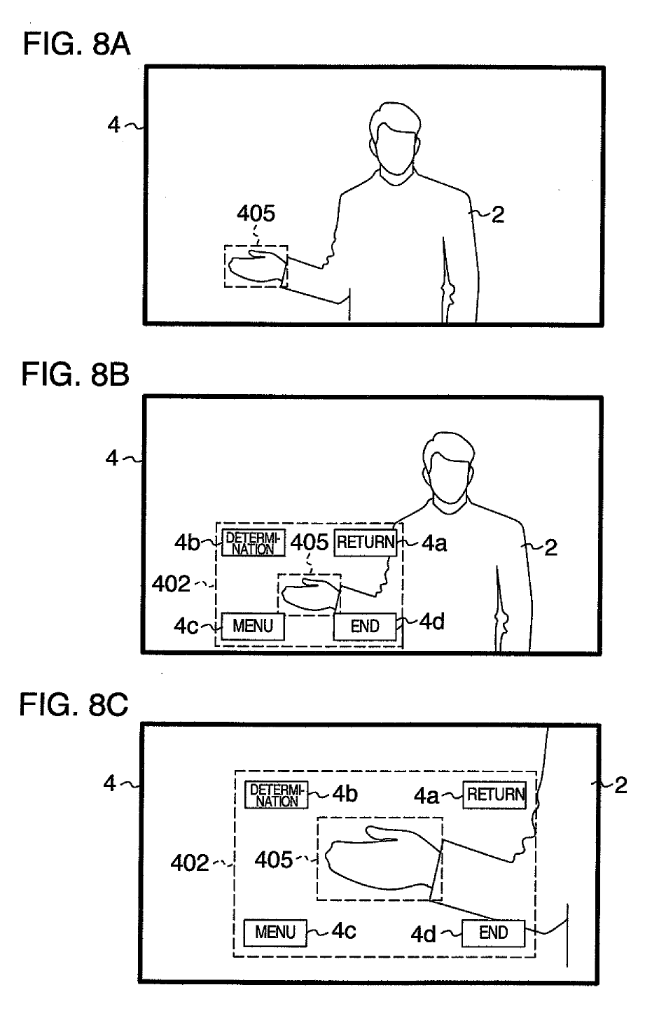

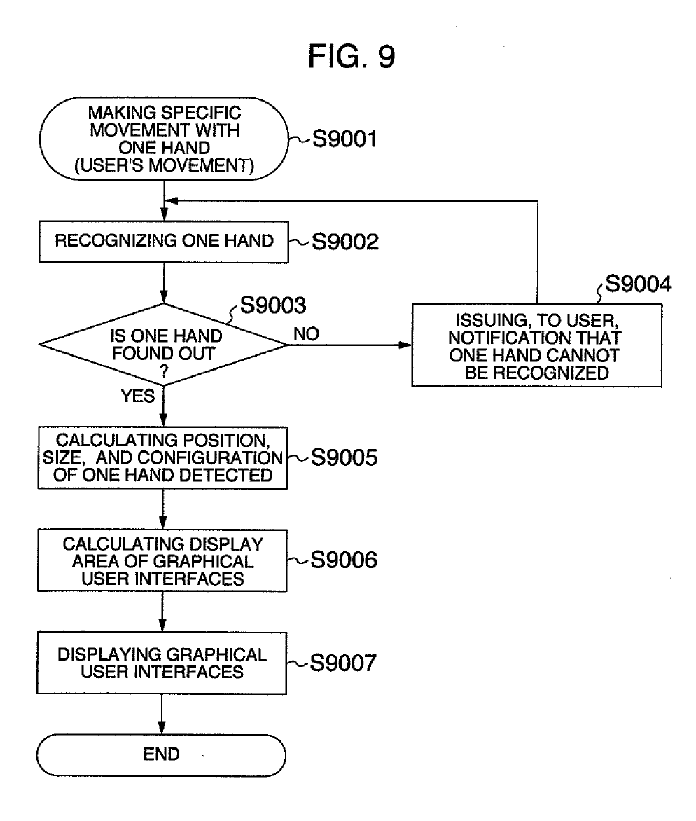

A feature in the present embodiment is as follows: Namely, in the input device 1 explained in the first embodiment, the display area of a graphical user interface is calculated in correspondence with the position, size, and configuration of one hand of the user 2. Hereinafter, referring to FIG. 8A to FIG. 8C and FIG. 9 the explanation will be given below concerning this scheme.

First, as illustrated in FIG. 8A, the user 2 makes a specific movement with one hand (S9001 in FIG. 9). The user 2 has only to make the specific movement at a position at which the user finds it easy to perform an operation. What is conceivable as the operation is the ones as were explained in the first embodiment. Next, the image recognition unit 100 recognizes the one hand (S9002 in FIG. 9). Here, the image recognition unit 100 may perform the image recognition of the one hand, or may detect an area in which the one hand is moving. Then, if the image recognition unit 100 has found it unsuccessful to detect the one hand (S9003 No in FIG. 9), the input device 1 issues, to the user, a notification to the effect that the one hand cannot be detected (S9004 in FIG. 9). Meanwhile, if the unit 100 has found it successful to detect the one hand (S9003 Yes in FIG. 9), the input device 1 calculates the position, size, and configuration of the one hand (S9005 in FIG. 9). This calculation makes it possible to estimate a range in which the user 2 can perform the operation. Next, the graphical-user-interface display-area calculation unit 101 calculates a display area of graphical user interfaces based on the position, size, and configuration of the one hand recognized (S9006 in FIG. 9), then displaying the graphical user interfaces (S9007 in FIG. 9). Hereinafter, referring to FIG. 8B and FIG. 8C, the explanation will be given below regarding examples of the display area of the graphical user interfaces based on the position, size, and configuration of the one hand recognized. In FIG. 8B and FIG. 8C, the reference numeral 405 denotes an area of the one hand recognized.

According to the embodiment illustrated in FIG. 8B and FIG. 8C, it becomes unnecessary for the user to raise one hand or both hands as was necessary in the embodiments illustrated in FIG. 3A to FIG. 3C or FIG. 5A to FIG. 5C. As a consequence, it becomes possible for the user to perform the operation by a simple movement using one hand alone, and the graphical user interfaces.

Similarly to the embodiment illustrated in FIG. 3B and FIG. 3C, the two types of display schemes are conceivable.

In the example in FIG. 8B, the graphical user interfaces 4a to 4d are simply deployed within a range in which the one hand of the user 2 can reach the graphical user interfaces with respect to the area 405 of the one hand recognized. In this case as well, however, the display area of the graphical user interfaces becomes narrower. As a consequence, by the amount equivalent thereto and depending on the person, the narrower display area causes a danger that the graphical user interfaces become difficult to see from a distance, and thus become difficult to operate.

In contrast thereto, in the example in FIG. 8C, the display area of the graphical user interfaces is enlarged so that the graphical user interfaces can be displayed as large as possible on the display device 4 with respect to the area 405 of the one hand recognized. This example makes it possible to enlarge the display area of the graphical user interfaces by making the display screen the maximum one. As a consequence, the graphical user interfaces become easier to see from a distance, and thus become easier to operate. Nevertheless, in the example in FIG. 8B, there is an advantage that the calculation amount needed for displaying the graphical user interfaces is small.

These two operation schemes may be switched by the user 2, using the operation-scheme setting unit 104. Also, if the one hand of the user 2 cannot be recognized for a predetermined time-interval, the graphical user interfaces may be deleted.

### 4th Embodiment

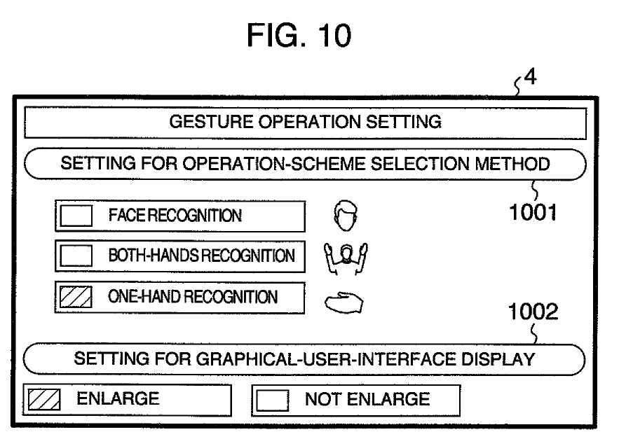

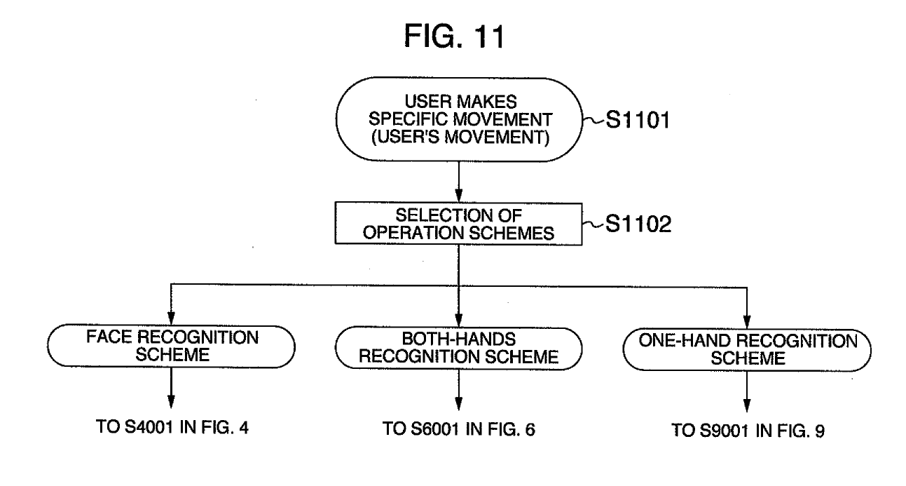

In the above-described first to third embodiments, the explanation has been given concerning each operation scheme based on which the user 2 performs the operation. In the present embodiment, referring to FIG. 10 and FIG. 11, the explanation will be given below concerning methods for selecting/setting the first to third embodiments in the operation-scheme setting unit 104. Here, for convenience of the explanation, the first embodiment, the second embodiment, and the third embodiment will be referred to as “face recognition scheme”, “both-hands recognition scheme”, and “one-hand recognition scheme”, respectively.

Various methods are conceivable as the methods for selecting/setting the first to third embodiments in the operation-scheme setting unit 104.

What is conceivable as one example of the methods is as follows: As illustrated in FIG. 10, a setting screen is provided, and the selection is made using touch-panel scheme or remote controller. In FIG. 10, 1001 denotes the setting for the operation-scheme selection method, and 1002 denotes the setting for the graphical-user-interface display. In the setting 1001 for the operation-scheme selection method, making the selection from among “face recognition scheme”, “both-hands recognition scheme”, and “one-hand recognition scheme” allows execution of the operation in the desired scheme. Also, in the setting 1002 for the graphical-user-interface display, it is selected whether or not the display area at the time when the graphical user interfaces are displayed should be enlarged in each scheme.

What is conceivable as another example of the methods is as follows: Each selection in the setting screen as is illustrated in FIG. 10 is made using gestures which are determined in advance. In this case, it is required to determine in advance the gestures for deciding the selective options of “face recognition”, “both-hands recognition”, and “one-hand recognition”, and “enlarge” and “not enlarge”, respectively.

FIG. 11 is a diagram for explaining the flow of selecting the operation schemes. First, the user 2 makes a specific movement, thereby starting an operation (S1101 in FIG. 11). Next, in the operation-scheme setting unit 104, the user makes the selection of the operation schemes in accordance with the above-described selection based on the setting screen or the above-described selection based on the gestures (S1102 in FIG. 11). Moreover, in order to perform the operation in accordance with the operation scheme selected by the selection, the user transitions to one of the first to third embodiments corresponding thereto.

It should be further understood by those skilled in the art that although the foregoing description has been made on embodiments of the invention, the invention is not limited thereto and various changes and modifications may be made without departing from the spirit of the invention and the scope of the appended claims.

1. An input device, comprising:
a camera which takes an image of an operator;
an image recognition unit which recognizes a partial portion of a body of said operator as the image taken by said photographing unit;
a display-area calculation unit which calculates a display area based on said partial portion of said body of said operator recognized by said image recognition unit, said display area being an operation range for a graphical user interface operated by said operator; and
a display screen which displays, within said display area calculated by said display-area calculation unit, said graphical user interface and something corresponding to said partial portion of said body of said operator.

2. The input device according to claim 1, wherein,
if said display area to be displayed within said display screen is smaller than said display screen, said display area is calculated in a manner of being enlarged, the enlarged display area then being displayed within said display screen.

3. The input device according to claim 1, wherein
said partial portion of said body recognized by said image recognition unit is a face.

4. The input device according to claim 1, wherein
said partial portion of said body recognized by said image recognition unit is both hands.

5. The input device according to claim 1, wherein
said partial portion of said body recognized by said image recognition unit is one hand.

6. An input device, comprising:
a camera which takes an image of an operator;
an image recognition unit which recognizes a partial portion of body of said operator as the image taken by said camera;
a display-area calculation unit which calculates a display area based on said partial portion of said body of said operator recognized by said image recognition unit, said display area being an operation range for a graphical user interface operated by said operator;
a display screen which displays, within said display area calculated by said display-area calculation unit, said graphical user interface and something corresponding to said partial portion of said body of said operator; and
a setting unit which changes said display area to be displayed within said display screen.

7. The input device according to claim 6, wherein
said setting unit can set either enlarging said display area or leaving said display area as it is.

8. An input device, comprising:
a camera which takes an image of an operator;
an image recognition unit which recognizes a partial portion of a body of said operator as the image taken by said camera;
a display-area calculation unit which calculates a display area based on said partial portion of said body of said operator recognized by said image recognition unit, said display area being an operation range for a graphical user interface operated by said operator;
a display screen which displays, within said display area calculated by said display-area calculation unit, said graphical user interface and something corresponding to said partial portion of said body of said operator, and
a setting unit which changes which portion to be selected and determined as said partial portion of said body recognized by said image recognition unit.

9. The input device according to claim 8, wherein
said portion of said body to be changed is a face, both hands, or one hand.
